(19) United States
(12) Patent Application Publication
(10) Pub. No.: US 2026/0346122 A1
(43) Pub. Date: Nov. 5, 2026

(54) LOTTERY TICKET VENDING MACHINES

(71) Applicant: Brightstar Global Solutions Corporation, Providence, RI (US)

(72) Inventors: Medina Marie Topalian, East Greenwich, RI (US); Robert Corvese, Warwick, RI (US)

(21) Appl. No.: 19/198,455

(22) Filed: May 5, 2025

(51) Int. Cl. A63F 3/06; B65H 35/10

(52) U.S. Cl. CPC A63F 3/0645; A63F 3/0655; B65H 35/10; B65H 2551/18; B65H 2553/43

(57) ABSTRACT

A lottery ticket vending machine configured to provide fast and easy instant lottery ticket pack loading, fast and easy instant lottery ticket pack unloading, and fast and easy instant lottery ticket pack reloading in ticket drawers of the lottery ticket vending machine.

### BACKGROUND

The present disclosure relates to lottery ticket vending machines.

Lottery tickets such as instant lottery tickets may be printed on a strip that may be rolled or fan-folded and provided as a pack of lottery tickets. Lottery tickets in such strips may be separated along perforations formed between adjacent tickets in the strips. Lottery tickets may vary in width and length. Lottery tickets may be sold from such packs using lottery ticket vending machines.

### BRIEF SUMMARY

In various embodiments, the present disclosure relates to a lottery ticket vending machine comprising: a housing; a display device supported by the housing; a ticket drawer in the housing the ticket drawer configured to hold a group of lottery tickets; a ticket burster in the housing, the ticket burster defining a ticket inlet and a ticket outlet, the ticket burster movable into alignment with the ticket drawer, the ticket burster comprising a sensor; a processor in the housing; and a memory device in the housing and that stores a plurality of instructions. When executed by the processor, the instructions cause the processor to: cause a display by the display device of a purchaser lottery ticket selection user interface that indicates a plurality of different selectable lottery games; based on a purchaser selected lottery game from the plurality of different selectable lottery games, cause the burster to be in alignment with the ticket drawer; cause the burster to obtain a leading lottery ticket from the group of lottery tickets in the ticket drawer; based on determined barcode image data for the leading lottery ticket, determine whether the leading lottery ticket is for the purchaser selected lottery game; and responsive to determining that the leading lottery ticket is for the purchaser selected lottery game, cause the burster to separate the leading lottery ticket from a second lottery ticket of the group of lottery tickets in the ticket drawer and to dispense that leading lottery ticket. When executed by the processor, the instructions further cause the processor to: responsive to determining that the leading lottery ticket is not for the purchaser selected lottery game: cause the burster to return the leading lottery ticket to the ticket drawer, cause the display by the display device of an indication that that the purchaser selected lottery game is not available, and cause the purchaser lottery ticket selection user interface to remove the indication that the purchaser selected lottery game is available for purchase.

In various other embodiments, the present disclosure relates to a lottery ticket vending machine comprising: a housing; a display device supported by the housing; a ticket drawer in the housing the ticket drawer configured to hold a group of lottery tickets; a ticket burster in the housing, the ticket burster defining a ticket inlet and a ticket outlet, the ticket burster movable into alignment with the ticket drawer, the ticket burster comprising a sensor; a processor in the housing; and a memory device in the housing and that stores a plurality of instructions. When executed by the processor, the instructions cause the processor to: cause a display by the display device of a purchaser lottery ticket selection user interface that indicates a plurality of different selectable lottery games; based on a purchaser selected lottery game from the plurality of different selectable lottery games, cause the burster to be in alignment with the ticket drawer; cause the burster to obtain a leading lottery ticket from the group of lottery tickets in the ticket drawer; and based on first determined barcode image data for the leading lottery ticket, cause the burster to separate the leading lottery ticket from a second lottery ticket of the group of lottery tickets in the ticket drawer and to dispense that leading lottery ticket. When executed by the processor, the instructions cause the processor to: based on second determined barcode image data for the second lottery ticket of the group of lottery tickets in the ticket drawer, responsive to determining that the second lottery ticket is for a different lottery game: cause the burster to return the second lottery ticket to the ticket drawer, and cause the purchaser lottery ticket selection user interface to subsequently add an indication that the different lottery game is available for purchase.

In various other embodiments, the present disclosure relates to a lottery ticket vending machine comprising: a housing; a display device supported by the housing; a ticket drawer in the housing the ticket drawer configured to hold a group of lottery tickets; a ticket burster in the housing, the ticket burster defining a ticket inlet and a ticket outlet, the ticket burster movable into alignment with the ticket drawer, the ticket burster comprising a sensor; a processor in the housing; and a memory device in the housing and that stores a plurality of instructions. When executed by the processor, the instructions cause the processor to: cause a display by the display device of a purchaser lottery ticket selection user interface that indicates a plurality of different selectable lottery games; based on a purchaser selected lottery game from the plurality of different selectable lottery games, cause the burster to be in alignment with the ticket drawer; cause the burster to obtain a leading lottery ticket from the group of lottery tickets in the ticket drawer; and based on first determined barcode image data for the leading lottery ticket, cause the burster to separate the leading lottery ticket from a second lottery ticket of the group of lottery tickets in the ticket drawer and to dispense that leading lottery ticket. When executed by the processor, the instructions cause the processor to: based on second determined barcode image data for the second lottery ticket of the group of lottery tickets in the ticket drawer, responsive to determining that the second lottery ticket is not for the purchaser selected lottery game: (a) cause the burster to return the second lottery ticket to the ticket drawer, (b) cause the purchaser lottery ticket selection user interface to remove the indication that the purchaser selected lottery game is available for purchase, and (c) cause the purchaser lottery ticket selection user interface to add an indication that a different lottery game associated with the second lottery ticket is available for purchase.

Additional features are described in, and will be apparent from, the following Detailed Description and the figures.

### BRIEF DESCRIPTION OF THE SEVERAL VIEWS OF THE DRAWINGS

FIG. 1A is a front view of an example instant lottery ticket.

FIG. 1B is a rear view of the example lottery ticket of FIG. 1A showing an example bar code on the back of the lottery ticket.

FIG. 2 is a front perspective view of a lottery ticket vending machine of one example embodiment of the present disclosure shown with a front door thereof in a closed position.

FIG. 3 is a front perspective view of the lottery ticket vending machine of FIG. 2 shown with the front door thereof in an open position, shown with a left side wall panel thereof removed, showing three ticket drawer columns and three movable ticket bursters respectively associated with the three ticket drawer columns, and showing a ticket collection receptacle of the front door.

FIG. 4 is a front view of the lottery ticket vending machine of FIG. 2 shown with the front door thereof in the open position, shown with the left side wall panel thereof removed, showing the three ticket drawer columns and the three movable ticket bursters respectively associated with the three ticket drawer columns, and showing the ticket collection receptacle of the front door.

FIG. 5 is an enlarged perspective view of one of the ticket drawer columns and the ticket burster associated with that ticket drawer column of the lottery ticket vending machine of FIG. 2.

FIG. 6 is an enlarged fragmentary perspective view of the ticket drawer column and the ticket burster of FIG. 5.

FIG. 7 is another enlarged fragmentary perspective view of the ticket drawer column and the ticket burster of FIG. 5.

FIG. 8 is an enlarged fragmentary side view of the ticket drawer column and the ticket burster of FIG. 5.

FIG. 9 is a further enlarged fragmentary side view of the ticket drawer column and the ticket burster of FIG. 5.

FIG. 10 is a flow chart showing a first method of operating the lottery ticket vending machine of FIG. 2.

FIG. 11 is a flow chart showing a second method of operating the lottery ticket vending machine of FIG. 2.

### DETAILED DESCRIPTION

In various embodiments, the present disclosure relates to a lottery ticket vending machine that is configured to provide a fast and easy ticket loading method, a fast and easy ticket unloading method for lottery tickets loaded in ticket drawers of the lottery ticket vending machine, and/or a fast and easy ticket reloading method for tickets loaded into ticket drawers of the lottery ticket vending machine.

In various embodiments, each of the ticket bursters of the lottery ticket vending machine includes a suitable ticket sensor configured to obtain code image data (such as bar code image data) from a leading lottery ticket in each of the ticket drawers associated with that ticket burster to assist in the ticket loading, unloading, and/or reloading methods.

In various embodiments, the lottery ticket vending machine includes one or more controllers configured to receive the code image data from the ticket sensors, use the code image data to facilitate: (1) activation of the lottery ticket packs loaded in the ticket drawers, and (2) deactivation of lottery ticket packs unloaded from the ticket drawers.

In various embodiments, the ticket loading method eliminates the need for an operator to manually and/or separately scan a code (such as a bar code) for each ticket pack loaded into one of the ticket drawers of the vending machine (for activation of the ticket pack and/or lottery tickets in the ticket pack) before the operator loads that pack into that ticket drawer.

In various embodiments, the ticket unloading method eliminates the need for an operator to manually and/or separately scan a code (such as a bar code) for each ticket pack unloaded from one of the ticket drawers of the vending machine after the operator unloads that pack from that ticket drawer.

For a better understanding of the present disclosure, example lottery tickets such as instant lottery tickets are first generally described herein.

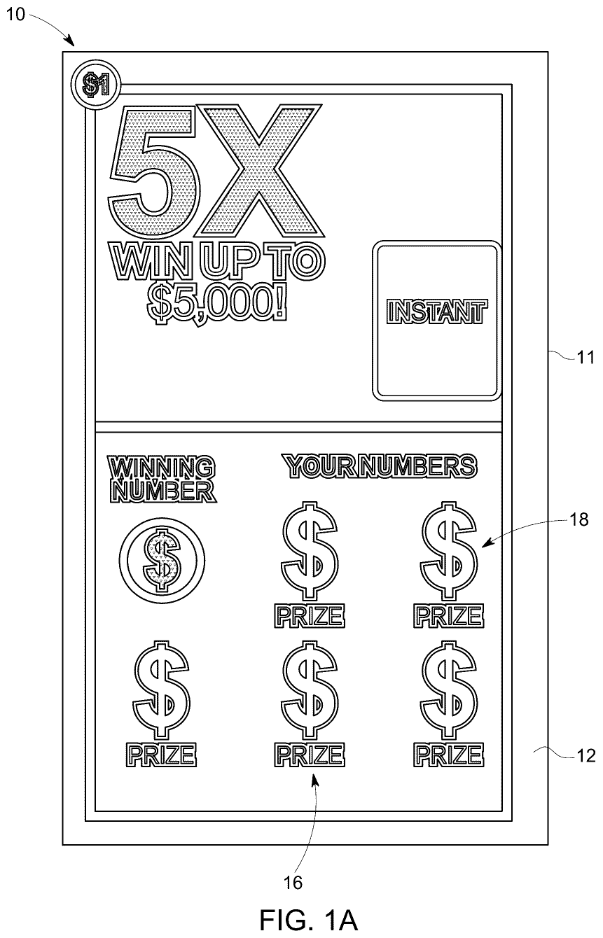

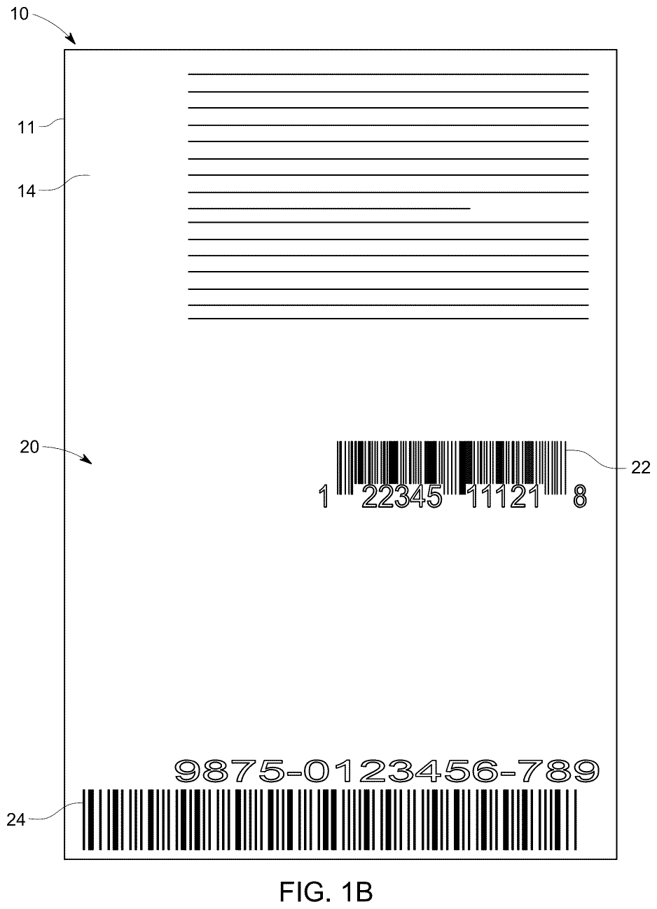

Various known instant lottery tickets are single game instant lottery tickets. As generally shown in FIGS. 1A and 1B, an example single game instant lottery ticket 10 includes: (1) a ticket substrate 11 having a front surface 12 and a back surface 14; (2) a predefined scratch-off area 16 the front surface 12; (3) variable lottery game indicia (not shown) printed on the predefined scratch-off area 16; (4) a scratch-off coating 18 (“SOC”) covering the variable lottery game indicia on the predefined scratch-off area 16; and (5) variable instant lottery ticket information indicia 20 printed on the back surface 14. The instant lottery ticket information indicia 20 can include text, one or more ticket numbers, one or more ticket codes such as example barcodes 22 and 24, and other instant lottery ticket information that is in human readable and machine readable forms. Certain of this instant lottery ticket information identifies: (a) the instant lottery ticket; (b) the pack (and the set and/or run) of instant lottery tickets that the instant lottery ticket is part of; and (c) other inventory control information. Various known single game instant lottery tickets include multiple predefined scratch-off areas, multiple sets of variable lottery game indicia printed on the predefined scratch-off areas, and multiple SOCs covering the variable lottery game indicia sets. Various known instant lottery tickets are multi-game instant lottery tickets and can be larger than single game tickets. Instant lottery tickets can also be of the known pull tab type. Various instant lottery tickets can have a width that varies from 2 to 4 inches and a length that varies from 2 to 12 inches. The term lottery ticket as used herein is intended to cover these various different types and other types of lottery tickets that can be dispensed in a same or similar manner as these types of lottery tickets.

As indicated above, various instant lottery tickets are arranged after manufacture (which includes after complete printing) in lottery ticket packs for storage, organization, sorting, picking, shipping to lottery ticket distributors and to lottery ticket sellers such as retailers, and for subsequent activation (such as on a pack by pack level). Instant lottery ticket packs can include a plurality of lottery tickets that are all of the same type, same size, and for the same game(s), and can be protected for storage and shipping by a transparent pack wrapping, such as transparent plastic wrapping, securely wrapped around the plurality of lottery tickets. A pack of lottery tickets can include all of the lottery tickets attached to each other but separated by perforations. Such lottery tickets of a pack can be detached from each other along such perforations. Tickets of each pack are often manufactured in a continuous strip that is fan-folded for convenient supply. These packs in the fan-folded form are configured to dispensing via a lottery ticket vending machine. After shipping to a lottery ticket seller, the lottery ticket seller can unwrap the lottery ticket pack and scan in one of the bar codes of one of the lottery tickets in the lottery ticket pack using a lottery terminal. The lottery terminal sends the bar code information to a central lottery system. The central lottery system checks that the ticket pack is authentic and at the correct lottery ticket seller, and then activates the lottery tickets in the ticket pack such that any winning lottery tickets of that pack can later be redeemed for any awards associated with those winning lottery tickets.

An example lottery ticket vending machine that is configured to expedite the ticket loading, unloading, and reloading methods in the ticket drawers of the lottery ticket vending machine is first described before describing these methods and before describing the ticket dispensing methods that the lottery ticket vending machine of the present disclosure is configured to perform. It should be appreciated that the lottery ticket vending machine that performs the ticket loading, unloading, reloading, and dispensing methods of the present disclosure can be alternatively configured in accordance with the present disclosure.

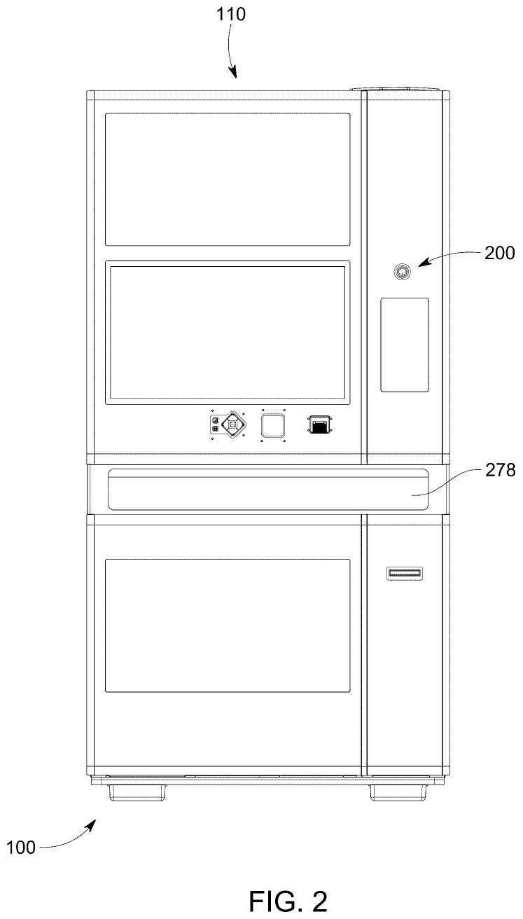

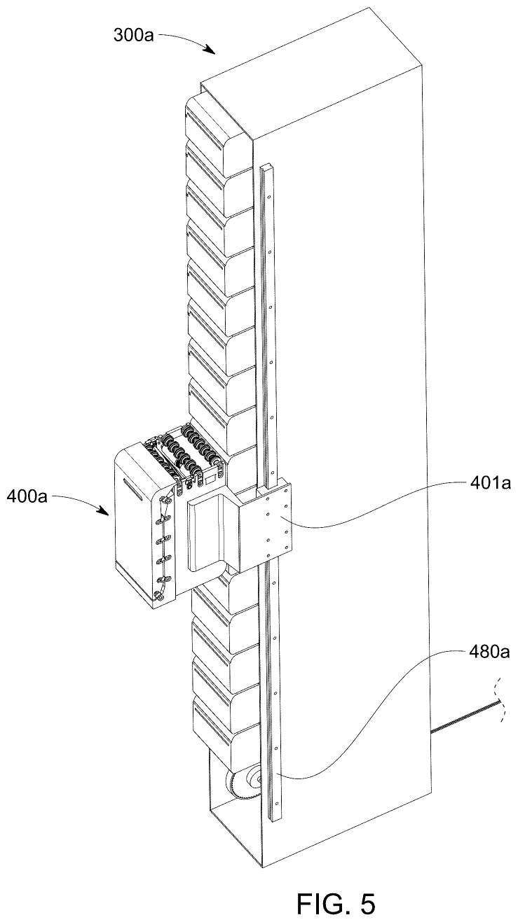

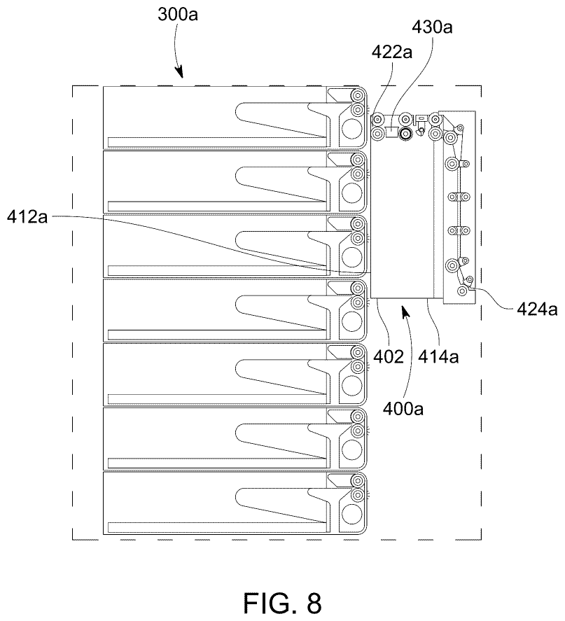

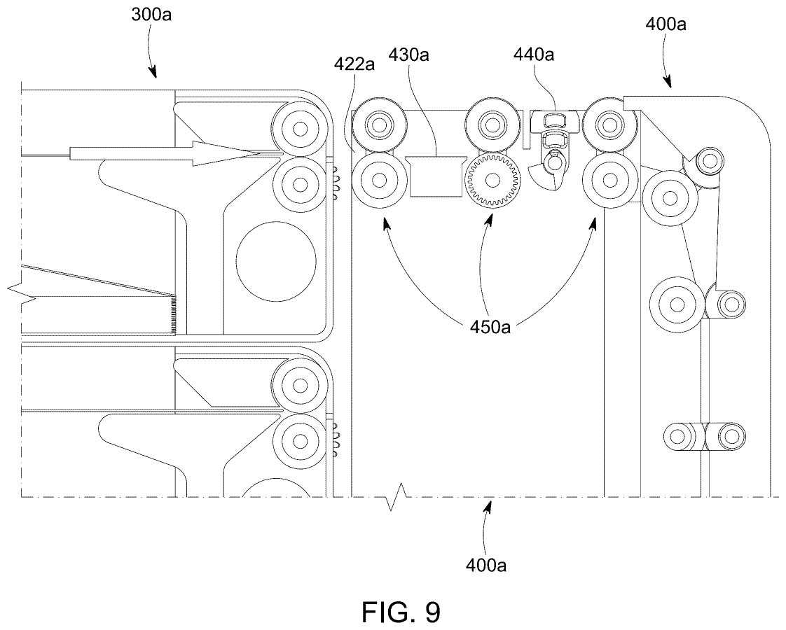

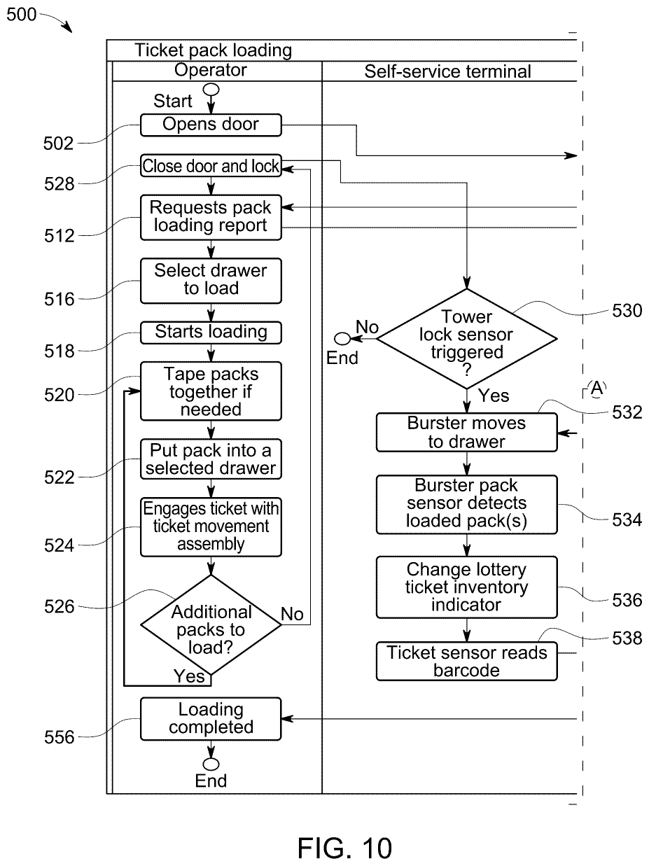

More specifically, FIGS. 2, 3, 4, 5, 6, 7, 8, and 9 illustrate a lottery ticket vending machine 100 of one example embodiment of the present disclosure. The lottery ticket vending machine 100 may be referred to herein as the “ticket vending machine” or the “vending machine” for brevity.

The illustrated example ticket vending machine 100 includes: (a) a machine housing 110 including a front door 200; (b) three ticket drawer columns 300a, 300b, and 300c positioned in and supported by the machine housing 110; and (c) three separate and independently movable ticket bursters 400a, 400b, and 400c positioned in the machine housing 110 and supported by burster supports (not labeled) positioned in and supported by the machine housing 110. The front door 200 includes a ticket collection receptacle 250 configured to receive separated lottery tickets from each of the ticket bursters 400a, 400b, and 400c. The quantity, positions, sizes, and configurations of the ticket drawer columns, the ticket drawers, and the ticket bursters can vary in accordance with the present disclosure.

It should be appreciated that the ticket vending machine 100 includes various other components that are conventional in the industry and/or that would be readily apparent to those of ordinary skill in the art. For example, the ticket vending machine 100 can include: (1) various electronic components (not shown) some of which can be contained in an electronic component holder (not labeled) positioned in and supported by the machine housing 110; and (2) various purchaser interface components (not labeled) that are part of the front door 200 of the machine housing 110. These components are only briefly described herein for brevity. Such electronic components can be arranged in any suitable manner. The electronic component holder can be in the form of a slide-out drawer to facilitate access to the various electronic components contained therein. The electronic components can form part of the control system for the ticket vending machine 100. Various electronic components can also be positioned in the machine housing 110 outside of the electrical component holder. The electronic components can include one or more controllers that control the operation of the ticket vending machine 100 including the movable ticket bursters 400a, 400b, and 400c as further discussed herein to facilitate the dispensing of each requested lottery ticket. The controller(s) can be any suitable type of controller (such as a programmable logic controller) that includes any suitable processor(s) (such as a microprocessor, a microcontroller-based platform, an integrated circuit, or an application-specific integrated circuit) and any suitable memory device(s) (such as random access memory, read-only memory, or flash memory). The memory device(s) store(s) instructions executable by the processor(s) to control operation of the ticket vending machine 100. The purchaser interface components include one or more display devices, one or more input devices, and one or more payment acceptors. The purchaser interface components enable purchasers to use such components to determine the lottery tickets available from the ticket vending machine 100, and to select and pay for any of those lottery tickets held by the ticket vending machine 100 that the purchaser desires to obtain. The purchaser interface components can display images and information to inform purchasers of the different lottery tickets available from the ticket vending machine 100 and to assist in completing the selection and purchase of such lottery tickets. These electronic components and purchaser interface components can take many different forms as well known in the industry, and are thus not described in detail herein for brevity.

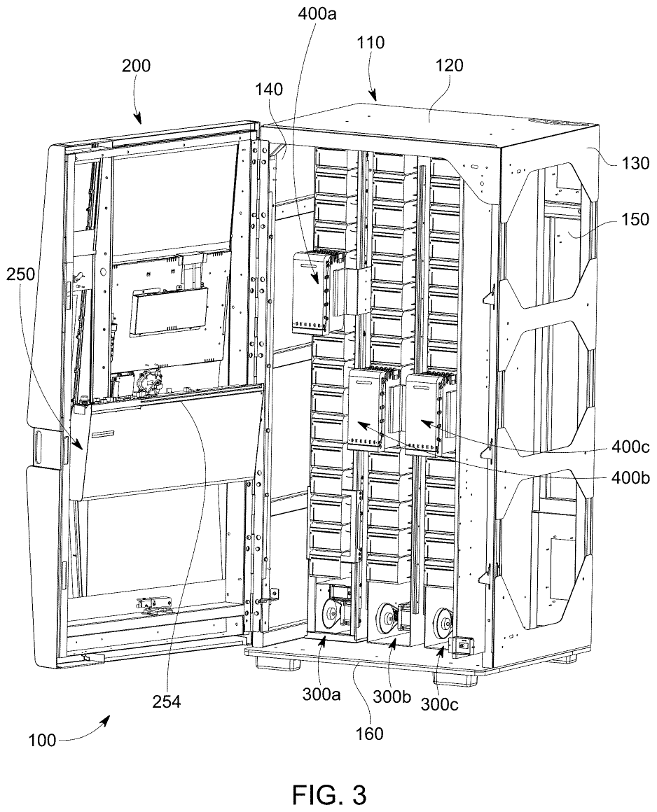

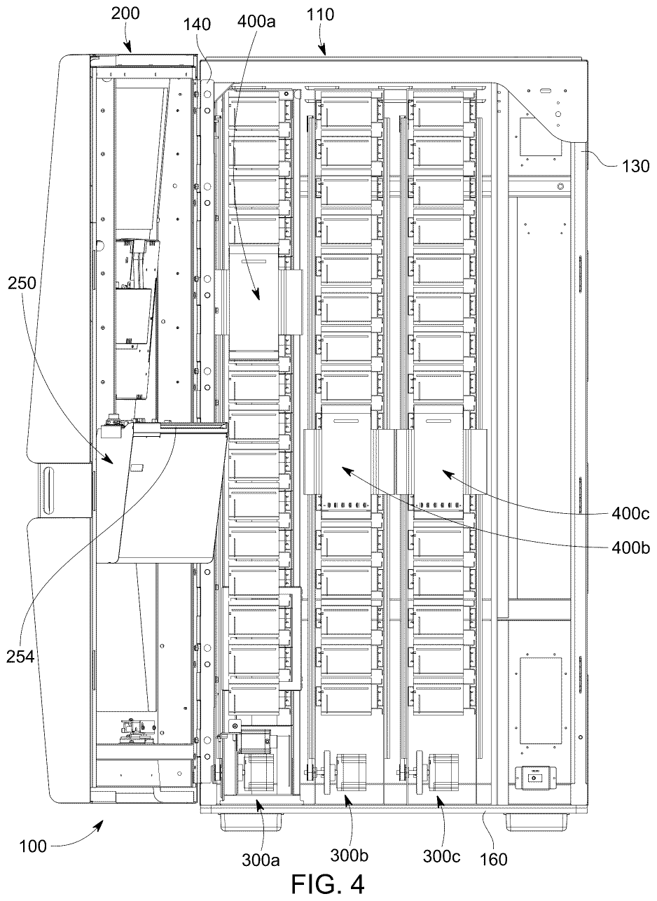

In this illustrated example embodiment, the machine housing 110 includes a top wall 120, spaced-apart side walls 130 and 140, a rear wall 150, a base 160, and the openable front door 200 pivotally connected to the side wall 140. The base 160 is configured to rest on a floor or other suitable support. The machine housing 110 includes suitable vertically extending supports (not labeled) configured to hold and support the respective ticket drawer columns 300a, 300b, and 300c. The front door 200 is moveable from a closed and locked position covering the open front face of the machine housing 110 as shown in FIG. 2 to an open position allowing access to the interior of the machine housing 110 as shown in FIGS. 3 and 4. The front door 200 is mounted by hinges (not labeled) to the side wall 140 of the machine housing 110. A door sensor (not shown) is suitably incorporated in the machine housing 110 and configured to sense when the front door 200 is in an open position. A suitable locking mechanism (not shown) is mounted on the front door 200 and the side wall 130 of the machine housing 110 to facilitate locking of the front door 200 in the closed position. A tower lock sensor (not shown) is suitably incorporated in the machine housing 110 and configured to sense when the front door 200 is locked in the closed position. When the front door 200 is closed and locked, the interior of the machine housing 110 is generally secured so as to be inaccessible except by an authorized person. The front door 200 can include one or more areas for any components supported by the front door and/or that are contained in and/or protected by the structure of the front door 200. The front door 200 can include one or more openings such as for a glass panel that enables people to see into the machine housing 110 and for one or more of the purchaser interface components (such as those described below). The size and configuration of the machine housing can vary in accordance with the present disclosure.

The ticket collection receptacle 250 of the front door 200 is configured to receive lottery tickets from each of the movable ticket bursters 400a, 400b, and 400c. The ticket collection receptacle 250 is configured to hold each lottery ticket received from the movable ticket bursters to enable the respective purchaser to retrieve the dispensed lottery ticket from the ticket collection receptacle 250. The ticket collection receptacle defines an elongated horizontally extending ticket receiving slot 254 (best seen in FIGS. 3 and 4). The ticket collection receptacle 250 and the front door define an elongated horizontally extending purchase ticket retrieval slot 278 (best seen in FIG. 2). The purchase ticket retrieval slot 278 is (and needs to be) large enough so that a purchaser can insert the purchaser's hand through the purchase ticket retrieval slot 278 to retrieve lottery tickets that are dispensed into the ticket collection receptacle 250. The ticket receiving slot 254 is (and needs to be) small enough so that a purchaser cannot insert the purchaser's hand through the ticket receiving slot 254 and thereby cannot access any of the ticket drawers of the ticket drawer columns 300a, 300b, or 300c. The position, size, and configuration of the ticket collection receptacle can vary in accordance with the present disclosure.

Each of the ticket drawer columns 300a, 300b, and 300c are identical in this example embodiment. For brevity, only ticket drawer column 300a is described in detail herein.

Likewise, the three movable ticket bursters 400a, 400b, and 400c are identical in this example embodiment. For brevity, only ticket burster 400a associated with the ticket drawer column 300a is described in detail herein.

Ticket drawer column 300a includes a series of aligned ticket drawers (not individually labeled in the Figures) that are vertically stacked in the column. These ticket drawers are numbered or otherwise separately identified by the lottery ticket vending machine. The ticket drawers of the other columns are also numbered or otherwise separately identified by the lottery ticket vending machine. Each of the ticket drawers is configured to hold one or more packs of lottery tickets such as instant lottery tickets for subsequent dispensing by the ticket vending machine 100. The ticket drawers can vary in quantity, size, and configuration depending upon the particular size of the ticket vending machine 100 and the quantity, size, and shapes of the lottery tickets that the ticket vending machine 100 can or will dispense. Each ticket drawer is configured to hold lottery tickets (such as instant lottery tickets of one or more lottery ticket packs) for selection by the purchasers. In various embodiments, the different ticket drawers can hold different lottery ticket packs for different lottery games, but it should be appreciated that two or more ticket drawers can hold the same type of instant lottery tickets.

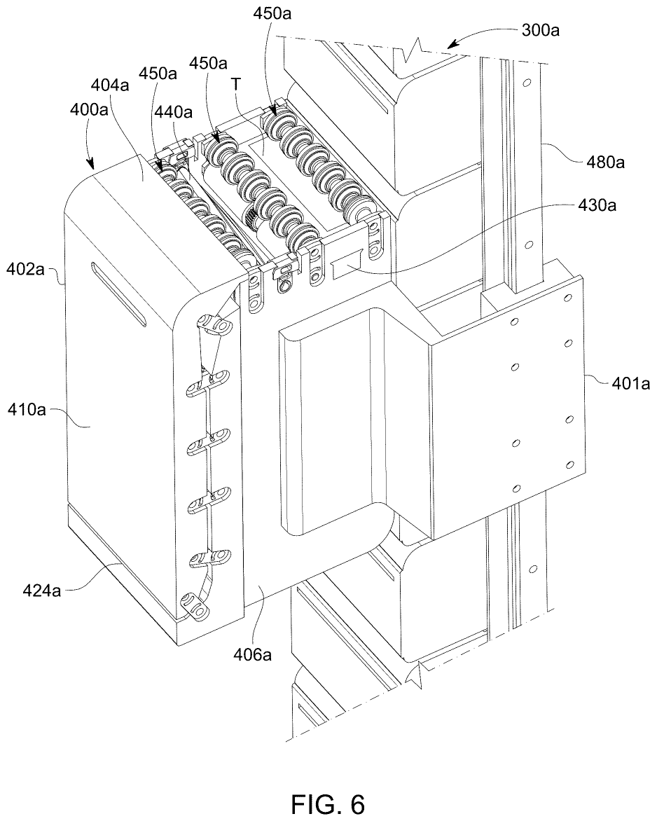

The lottery tickets in each of the ticket drawers of the ticket drawer column 300a are movable into the associated ticket burster 400a after the ticket burster 400a is moved into alignment with such ticket drawer for receipt, bursting, and dispensing of that lottery ticket (such as shown in FIGS. 6, 7, 8, and 9). The lottery tickets in each of the ticket drawers of the ticket drawer column 300a are also retractable back from the associated ticket burster 400a after the ticket burster 400a (prior to being separated by the buster 400a from the next lottery ticket of the strip of lottery tickets of the pack in the ticket drawer).

Each of the ticket drawers of each of the ticket drawer columns can include or be associated with a suitable ticket movement assembly (not shown). In various embodiments, the ticket movement assembly of the ticket drawer is configured to move the leading lottery ticket in the ticket drawer at least partially into the respective burster when that burster is aligned with that ticket drawer so that the ticket engagers of the burster can grip and then subsequently move that lottery ticket in that burster.

In various embodiments, the burster includes an actuator (not shown) configured to engage an actuation lever (not shown) or an actuation gear (not shown) of the ticket movement assembly (not shown) to cause the movement of the leading lottery ticket by the ticket drawer movement assembly. The ticket drawer movement assembly can include ticket engagers (such as rollers mounted on shafts (not shown)), gearing (not shown), and/or an actuation lever (not shown). The actuation lever or actuation gear is engagable by an actuator (not shown) or gear (not shown) of the burster (after the burster is aligned with the ticket drawer) to cause the ticket movement assembly to move a leading ticket in the ticket drawer into the burster and to retract the leading ticket back into the ticket drawer. It should be appreciated that the movement of the lottery tickets into and out of the bursters can be performed via other suitable mechanisms in other suitable manners.

Thus, the vending machine 100 is configured to cause a leading lottery ticket from each of the lottery ticket drawers to move into a burster, and if not separated by the burster, can be retracted from the burster back into the ticket drawer. This enables the vending machine 100 to read and use a code on one or more of the tickets from each ticket drawer during the ticket loading, unloading, reloading, and/or ticket dispensing methods such as but not limited to the manners described herein.

As best shown in FIGS. 3, 4, 5, and 6, the movable ticket burster 400a is supported by one or more burster supporters (such as burster supporter 480a). The burster supporters can be any suitable structure(s) that support(s) the ticket burster 400a in a manner that enables the ticket burster 400a to vertically move to any of the different ticket receipt positions that are associated with and in alignment with the respective ticket drawers of the ticket drawer column 300a. Each of the burster supporters also support the ticket burster 400a in a manner that enables the ticket burster 400a to vertically move into alignment with the ticket receptacle 250.

The ticket vending machine 100 includes one or more actuators (not shown) that control movement of the ticket burster 400a under control of the controller of the ticket vending machine 100 and/or the controller of the ticket burster 400a. In this example, an actuator (not labeled) is mounted at the bottom of the ticket drawer column 300a and coupled to the ticket burster 400a by suitable linkages (such as but not limited to pulleys and a drive belt (not labeled)). The actuator is configured to move the ticket burster 400a under the control of the controller(s) in the vertical (e.g., up and down) directions. The movable ticket burster 400a is thus moveable, via this actuator and linkages on the ticket burster supporters to different vertical locations including a plurality of the locations respectively associated and aligned with each of the ticket drawers of the ticket drawer column 300a such that the ticket burster 400a is positioned to receive one or more of the lottery tickets stored in each respective ticket drawer of the ticket drawer column 300a for loading purposes during the ticket loading process, and for obtaining and dispensing instant lottery tickets into the ticket receptacle 400 for the purchaser as requested by the purchaser.

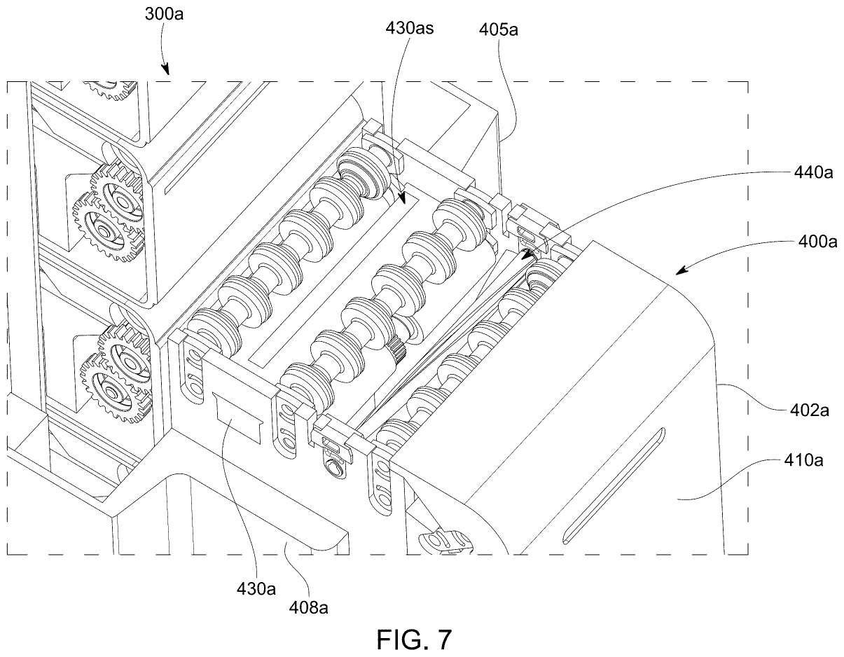

As best shown in FIGS. 6 and 7, the example movable ticket burster 400a includes: (a) a burster housing 402a; (b) one or more burster supporter connecters (such as burster support connector 404a connecting the burster housing 402a and the burster supporter 480a); (c) a ticket sensor 430a in and supported by the burster housing 402a; (d) a ticket cutter 440a in and supported by the burster housing 402a; (e) a plurality of ticket engagers 450a supported by the burster housing 402a; (f) a burster controller (not shown); and (g) a pack sensor (not shown). The size and configuration of the ticket burster can vary in accordance with the present disclosure.

The burster housing 402a includes a top member 404a, spaced-apart side members 406a and 408a, a front member 410a, a rear member 412a, and a bottom member 414a. The burster housing 402a also includes a plurality of internal members (not individually labeled) that define a ticket inlet 422a, through which the ticket burster 400a is configured to receive a lottery ticket (such as lottery ticket T as shown in FIG. 6) from a ticket drawer of the ticket drawer column 300a, a ticket outlet 424a through which the ticket burster 400a is configured to dispense the received instant lottery ticket into the ticket collection receptacle 250, and a ticket movement path (not labeled) extending from the ticket inlet 422a to the ticket outlet 424a and through which the lottery ticket is moved through the ticket burster 400a.

The ticket cutter 440a is positioned in the burster housing 402a and configured to rotate to cut the perforations attaching each instant lottery ticket that moves along the ticket movement path in the ticket burster 400a to the next instant lottery ticket of the continuous strip of lottery tickets received from the respective ticket drawer. The ticket cutter 440a is configured to make such cut along the perforations between the two connected instant lottery tickets of such strip. The ticket cutter 440a is controlled by the burster controller and/or the controller of the ticket vending machine 100. In this example embodiment, the ticket cutter 440a is inwardly positioned (i.e., positioned downstream) from the ticket inlet 422a. After the ticket cutter 440a cuts the instant lottery ticket requested by the purchaser from the respective ticket drawer, the ticket drawer can retract the portion of the next instant lottery ticket (of the strip of lottery tickets) from the ticket burster 400a before the ticket burster 400a moves from the ticket receipt position aligned with that ticket drawer. In other embodiments, the ticket burster 400a can be configured such that the ticket cutter is positioned closer to or on the other side of the ticket inlet (i.e., positioned upstream of the ticket inlet) such that after the ticket cutter cuts the lottery ticket along the perforations connecting that lottery ticket to the next lottery ticket in the strip, the ticket drawer may not need to withdraw the next instant lottery ticket in the strip or may only need to withdraw the next instant lottery ticket in the strip a relatively small distance. The position, size, and configuration of the ticket cutter can thus vary in accordance with the present disclosure.

In other embodiments, the ticket burster 400a can be configured such that the burster housing 402a is rotatable about a horizontal axis to separate (via a tearing and/or twisting motion) each instant lottery ticket along the perforations connecting that instant lottery ticket to the next lottery ticket in the strip. In such embodiments, the ticket drawer may not need to withdraw the next instant lottery ticket of the strip or may only need to withdraw the next instant lottery ticket of the strip a relatively small distance. In such embodiments, the ticket burster may not need a ticket cutter.

The ticket burster 400a is thus configured to burst the perforations between the leading lottery ticket being dispensed and the next lottery ticket of the strip so as to enable the dispensed lottery ticket to be dispensed into the ticket receptacle 250. This also prevents a person from being able to pull an extended number of lottery tickets from one of the ticket packs in one of the ticket drawers. It should be appreciated that the ticket burster 400a can be moved to a dispensing location for each instant lottery ticket dispensed. It should also be appreciated that the ticket burster can move to a different location for any lottery ticket that is deemed to be bad or non-dispensable for any reason, and to deposit that ticket into a suitable rejection area.

The ticket vending machine of the present disclosure can have more than one ticket burster associated with each ticket drawer column such that they can operate at the same time, or such that one or more ticket bursters are back-ups in case there is an issue with one of the other ticket bursters for that ticket drawer column.

The ticket engagers 450a include multiple driven rollers (not labeled) and multiple guide rollers (not labeled). The driven rollers are rotated by suitable actuators such as motors (not shown) under the control of the burster controller and/or the controller of the ticket vending machine 100. The driven rollers and the guide rollers are configured to move (such as by pulling) and guide each lottery ticket along the ticket movement path and out of the ticket outlet 424a. In alternative embodiments, the ticket engagers are configured to grip and pull each lottery ticket from the respective ticket drawer.

The burster controller (not shown) can be any suitable type of controller (such as a programmable logic controller) that includes any suitable processor(s) (such as a microprocessor, a microcontroller-based platform, an integrated circuit, or an application-specific integrated circuit) and any suitable memory device(s) (such as random access memory, read-only memory, or flash memory). The memory device(s) stores instructions executable by the processor(s) to control operation of the ticket burster 400a. The burster controller can be hard wired or wirelessly connected to and in communication with the cutter 440a, the actuators for the driven rollers 450a, any actuators of the ticket burster 400a that cause the movement of the ticket burster 400a, and the ticket sensor 430a (as further described below). In such embodiments, the burster controller can be wirelessly connected to and in communication with the controller of the ticket vending machine 100. In other embodiments, the ticket burster does not include a controller and is completely controlled by the controller of the ticket vending machine 100. In such embodiments, the controller of the ticket vending machine 100 can be hard wired to or wirelessly connected to and in communication with the cutter, the actuators (such as the motors) for the driven rollers, any actuators (such as the motors) on the ticket burster or the burster supporter that cause the movement of the ticket burster, and the ticket sensor.

The pack sensor (not shown) of the ticket burster 400a is positioned in and supported by the housing 402a of the ticket burster 400a. The pack sensor is suitably configured to detect the contents of the corresponding ticket drawer of ticket drawer column 300a, such as the utilized capacity of the drawer. The pack sensor is configured to communicate data to the burster controller and/or the controller of the ticket vending machine 100.

The ticket sensor 430a of the ticket burster 400a is positioned in and supported by the housing 402a of the ticket burster 400a. The ticket sensor 430a extends transversely along the entire width or substantially the entire width of the ticket burster 400a such that it can obtain an image of part or all of the entire width of each lottery ticket or codes (such as bar codes) thereon that moves through the ticket burster 400a as that lottery ticket moves above the ticket sensor 430a. In this example embodiment, the ticket sensor 430a includes a scanning window 430as that is below the ticket movement path in the ticket burster 400a and to enable the ticket sensor 430a to scan upwardly toward the lottery ticket. In this example embodiment, the ticket sensor 430a is below the ticket movement path and thus scans upwardly toward the lottery ticket. The ticket sensor 430a is configured to read the bar code of the lottery ticket as that lottery ticket moves from a ticket drawer into the ticket burster 400a. In other words, the ticket sensor 430a is configured to scan part of the lottery ticket as that lottery ticket moves in the ticket movement path and through a scan area above the ticket sensor 430a. The ticket sensor 430a is configured to communicate related code image data (regarding the lottery ticket and specifically for the barcode of the lottery ticket) to the burster controller and/or the controller of the ticket vending machine 100. The burster controller and/or the controller of the ticket vending machine 100 are configured to use this ticket related code data and determine the code information such as the bar code information of the lottery ticket. After the burster controller and/or the controller of the ticket vending machine 100 determines that the code information of the lottery ticket, the burster controller and/or the controller of the ticket vending machine 100 can take one or more of a series of different actions depending on the mode of operation of the vending machine 100.

As mentioned above, the vending machine 100 of various embodiments of the present disclosure is configured to enable fast and easy ticket loading, ticket unloading, ticket reloading, and/or ticket dispensing.

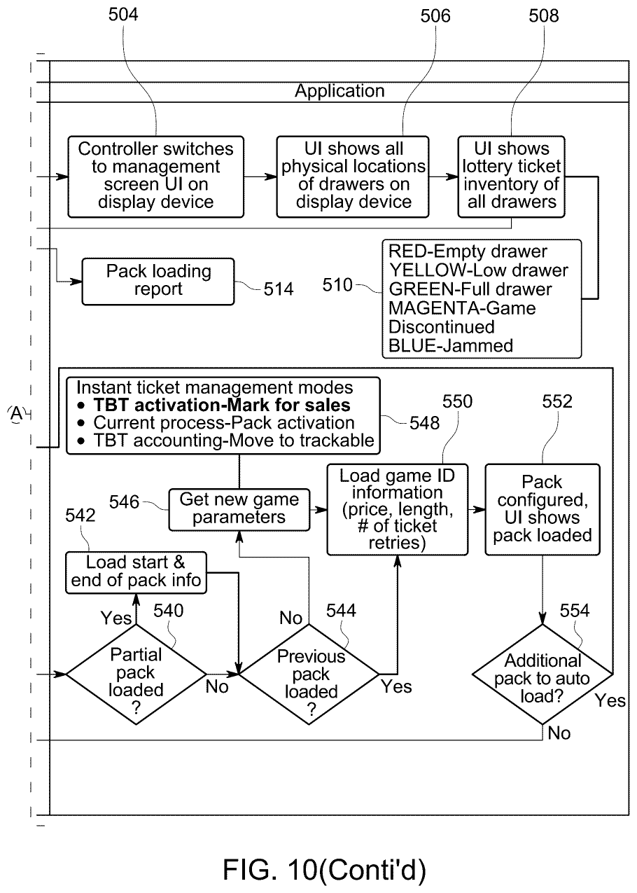

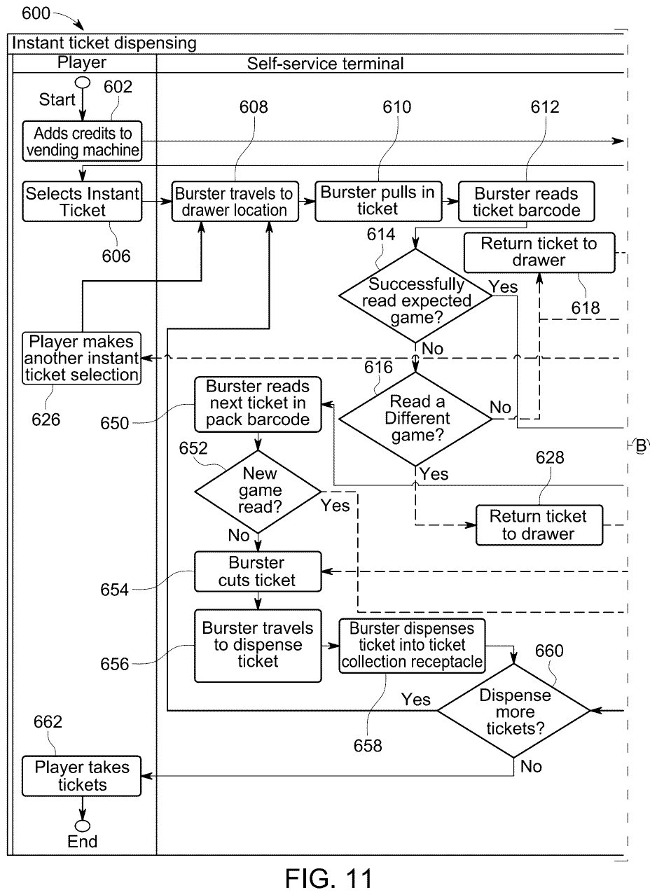

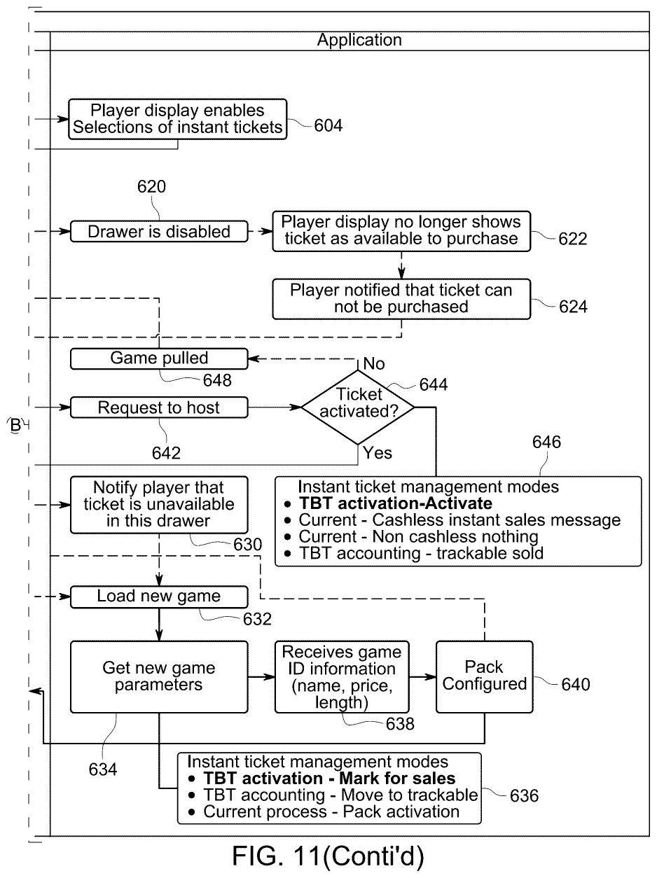

FIG. 10 and FIG. 11 are respectively flowcharts of different example methods 500 and 600, respectively, of operating the vending machine 100 of the present disclosure in different modes. In various embodiments, the methods 500 and 600 are at least partially represented by a set of instructions stored in one or more memories and executed by one or more processors of one or more of the controllers of the vending machine 100. Although the methods 500 and 600 are described with reference to the flowcharts shown in FIGS. 10 and 11, other processes of performing the acts associated with this illustrated methods can be employed. For example, the order of certain of the illustrated blocks or diamonds can be changed, certain of the illustrated blocks or diamonds can be optional, or certain of the illustrated blocks or diamonds may not be employed.

Generally, the vending machine 100 performs the methods 500 and 600 to enable lottery tickets to be added and removed from each of the ticket drawers of the vending machine 100, to activate the lottery ticket packs loaded in the ticket drawers of the vending machine 100, to verify the lottery ticket packs loaded in the ticket drawers for the operator, to enable replacements of the lottery tickets loaded in the drawers, to enable the vending machine to ready itself for the dispensing of the lottery tickets from the respective ticket drawers of the vending machine 100 and to enable the vending machine to dispense purchased lottery tickets from the respective ticket drawers of the vending machine 100.

FIG. 10 illustrates one example ticket loading method 500 in accordance with the present disclosure.

The vending machine 100 is configured such that the operator can open the door 200 of the vending machine 100 to load, unload, and/or reload lottery tickets into or from the ticket drawers of the vending machine 100, as indicated by block 502. The door sensor such as a tower lock sensor (not shown) of the vending machine 100 senses the door 200 being opened and sends an appropriate signal to the controller of the vending machine 100.

After the controller receives a signal that the door is opened, the controller causes the display device of the vending machine 100 (that normally displays the purchaser lottery ticket selection user interface) to display a management screen user interface, as indicated by block 504. In this example, the display device includes or is associated with a touch screen that enables users to make inputs via such display device and touch screen and thus make inputs via the management screen user interface.

The controller causes the management screen user interface to display indications of all of physical locations of the ticket drawers of the ticket drawer columns 300a, 300b, and 300c on the display device, as indicated by block 506.

The controller causes the management screen user interface to display status indications of the known lottery tickets (i.e., the known inventory of lottery tickets) for each of the ticket drawers, as indicated by block 508.

In various embodiments, the status indications of the lottery ticket inventory for each of the ticket drawers includes a status indicator such as a color indicator that indicates a vending machine known status of the lottery ticket inventory in each of the ticket drawers, as indicated by block 510. In this example embodiment, these status indicators include: (1) a red empty ticket drawer status indicator; (2) a yellow low inventory ticket drawer status indicator; (3) a green full ticket drawer status indicator; (4) a magenta game discontinued lottery game ticket drawer status indicator; and (5) a blue ticket drawer jammed status indicator. The colors and/or other attributes of these status indicators can vary in accordance with the present disclosure. It should be appreciated that the controller of the vending machine 100 determines this status based on data received regarding the lottery tickets placed in each of the ticket drawers and the purchases of those lottery tickets such as explained herein.

The controller causes the management screen user interface to enable the operator to request a pack loading report, as indicated by block 512.

Responsive to the operator using the management screen user interface to request a pack loading report, the controller causes the management screen user interface to display the pack loading report, as indicated by block 514. The displayed pack loading report indicates the respective lottery tickets such as the lottery ticket groups in each of the ticket drawers. For purposes of the present disclosure, a lottery ticket group in a ticket drawer comprises all of the lottery tickets in that ticket drawer. The lottery ticket group in each ticket drawer can include one pack of lottery tickets, multiple attached full packs of lottery tickets, a partial pack of lottery tickets, multiple attached partial packs of lottery tickets, or one or more full packs of lottery tickets attached to one or more partial packs of lottery tickets. The methods of the present disclosure account for such varying situations. The pack loading report can also indicate any empty ticket drawers.

In various embodiments, the vending machine 100 is configured to enable the operator to select the ticket drawer that the operator desires to load with lottery tickets, as indicated by block 516. The management screen user interface is configured to accept the operator input and send appropriate signals to the controller of the vending machine 100 based on the operator inputs.

In various such embodiments, if the operator wants to load a partial lottery ticket pack into a ticket drawer, the vending machine 100 can require a manual operator entry via the management screen user interface.

In various embodiments, the vending machine 100 is configured to enable the operator bypass the step of selecting, via the management screen user interface, the ticket drawer that the operator desires to load with a single full pack of lottery tickets, and enables the operation to simply load of the single full lottery ticket pack into that ticket drawer, and thereafter the vending machine 100 determines the ticket pack loaded into the that ticket drawer.

In various embodiments, the vending machine 100 is configured to enable the operator to load one or more lottery ticket packs into the selected ticket drawer, as indicated by block 518. In various situations, the one or more lottery ticket packs can be a single lottery ticket pack, and in various situations the one or more of the lottery ticket packs can be multiple lottery ticket packs that are suitably attached such as by using tape to attach a last lottery ticket of a first lottery ticket pack to a first lottery ticket of a second lottery ticket pack. The attached lottery packs can have lottery tickets for the same lottery game or for different lottery games. It should be appreciated that while it is desirable for the operator to not placed attached lottery tickets from different lottery games into a single ticket drawer, that the vending machine 100 is configured to address such situations.

In various embodiments, the vending machine 100 is configured to account for different situations where the operator tapes certain lottery ticket packs together before loading such connected lottery ticket packs in a ticket drawer, as indicated by block 520.

The vending machine is configured to enable the operator to put one or more lottery ticket packs into the selected ticket drawer, as indicated by block 522. The lottery tickets in the ticket drawer after the operator has finished loading the ticket drawer can thus include any pre-existing lottery tickets or partial or full lottery ticket packs in the ticket drawer (which are attached by the operator to one or more new lottery ticket packs). As indicated above, such lottery tickets from multiple partial or full packs are sometimes referred to herein as the lottery ticket group.

The vending machine 100 is configured to enable the operator to position the lottery ticket group in the ticket drawer such that the leading lottery ticket of the lottery ticket group is in engagement with the ticket movement assembly of the ticket drawer, as indicated by block 524. The ticket movement assembly can be any suitable mechanism such that the ticket movement assembly is able to move the leading lottery ticket (as well as the other lottery tickets) in the ticket drawer into the respective burster when that burster is aligned with that ticket drawer during the loading or dispensing processes.

It should be appreciated that the determination of which lottery tickets are loaded in each of the ticket drawers occurs after the operator has loaded all of the ticket drawers and has closed the door of the vending machine.

The vending machine 100 thus configured to enable the operator to determine whether there are additional ticket drawers to load, as indicated by block 526. Responsive to the operator determining that there are additional ticket drawers to load, the vending machine is configured to enable the operator to repeat the portions of the method 500 described above and indicated by blocks 520 through 526 for each of the additional ticket drawers.

Responsive to the operator determining that there are no additional lottery tickets to load in any of the ticket drawers, the vending machine 100 is configured to enable the operator to close and lock the door 200 of the vending machine 100, as indicated by block 528. When the door is closed, the door sensor such as the tower lock sensor (not shown) of the vending machine 100 senses that door 200 is closed and locked and sends an appropriate signal to the controller of the vending machine 100.

The controller determines whether the tower lock sensor was triggered, as indicated by block 530.

Responsive to the controller determining that the tower lock sensor was not triggered, the controller causes the management screen user interface to show an indication that the door was not correctly closed and locked.

Responsive to the controller determining that the tower lock sensor was triggered, the controller begins the autoload part of the method 500.

The controller determines the column in which a first loaded ticket drawer is located. The controller communicates with the burster controller to cause the burster associated with the determined column to move to that first loaded ticket drawer, as indicated by block 532.

In various embodiments, the pack sensor (not shown) of the burster detects a quantity or estimated quantity of lottery tickets in that respective ticket drawer, as indicated by block 534. The pack sensor communicates information about the quantity of lottery tickets in the ticket drawer and thus the utilized capacity of that ticket drawer to the controller of the vending machine 100.

The controller determines, stores, and changes the status indication displayed by the management screen user interface of the lottery ticket inventory associated with the ticket drawer to suitably reflect the data from the pack sensor, as indicated by block 536. For example, if the pack sensor detects that the lottery tickets in the ticket drawer fills the ticket drawer to capacity, the status indication of the lottery ticket inventory displayed by the management screen user interface will be green to indicate a full ticket drawer (as mentioned in the above example embodiment).

The burster controller causes the burster to pull the leading ticket of the lottery tickets in that ticket drawer into the burster. In this example, the ticket engagers of the burster grip and then move the leading lottery ticket into the burster.

The ticket sensor of the burster reads the barcode of the leading lottery ticket from that ticket drawer, as indicated by block 538. The ticket sensor sends the barcode image data to the controller of the vending machine 100.

The controller of the vending machine 100 determines whether the leading lottery ticket in the ticket drawer is part of a lottery ticket pack or a partial lottery ticket pack based on the barcode image data, as indicated by block 540. In various embodiments, if the lottery ticket pack is a full pack, the controller of the vending machine 100 uses received data regarding the lottery game associated with that lottery ticket pack to determine the quantity of all of the lottery tickets of that pack in the ticket drawer. In various embodiments, if the lottery ticket pack is a full pack, the controller of the vending machine 100 can use the data from the barcode of that first lottery ticket to determine the quantity of all of the lottery tickets of that pack in the ticket drawer.

It should be appreciated that as mentioned above in various embodiments as part of the loading process, the vending machine 100 is configured to enable the operator to, for any partial lottery ticket packs, first scan the first and last lottery tickets of that lottery ticket pack via a scanner of the vending machine 100. The vending machine 100 stores this information. When the burster reads a first ticket from a lottery ticket pack in a lottery ticket drawer, the controller of the vending machine 100 can thus determine using this information if that lottery ticket is from a partial lottery ticket pack. This process enables the vending machine 100 to know the total quantity of all of the lottery tickets in that ticket drawer for that partial pack.

In various such embodiments, the vending machine management screen user interface includes a button selection for adding a partial pack (and/or for a low volume full pack that exists for certain higher purchase amount lottery games that have a relatively low quantity of lottery ticket tickets in that lottery ticket pack). The management screen user interface can prompt the operator to scan barcodes on the first and last lottery tickets in such lottery ticket pack using the scanner on the door of the vending machine 100. The controller of the vending machine 100 can add that quantity to the previous inventory count, if any, for that ticket drawer.

It should be appreciated that the barcodes scanned in the partial pack each have a ticket number as part of that barcode. This enables the controller of the vending machine 100 to know how many lottery tickets are in the partial lottery ticket pack.

It should be appreciated that when multiple full lottery ticket packs are taped together, the vending machine can also require manual entry and scanning of last lottery ticket in each lottery ticket pack (for each lottery ticket pack beyond the first lottery ticket pack).

As mentioned above, it should also be appreciated that as part of the loading process or prior to the loading process, the vending machine 100 is configured to receive lottery ticket game data from one or more central lottery systems that provide the vending machine 100 with suitable data regarding all of the then available lottery games that the vending machine 100 may receive lottery tickets for. The central lottery system(s) can update this data on a regular basis or on an as needed basis such that the vending machine 100 always knows what lottery games are available and can make various decisions such as described herein regarding the lottery tickets loaded into ticket drawers of the vending machine 100.

It should also be appreciated that for a full lottery ticket pack, the quantity of lottery tickets in that lottery ticket pack is associated with the data such as the Game ID data received from the central lottery system.

Responsive to the controller determining that the lottery tickets of a lottery ticket group in a ticket drawer is a partial pack, the controller loads the start and end of pack data, as indicated by block 542. The start and end of pack data is based on the barcode image data.

Responsive to the controller determining that the lottery ticket group is not a partial pack or after loading the start and end of pack data of a partial pack, the controller determines whether the lottery ticket group in the ticket drawer was previously loaded, as indicated by block 544. In other words, if an original lottery ticket pack was placed in that ticket drawer and was previously determined during a previous loading process, if parameters for the lottery ticket pack for that lottery ticket game are the same and thus already present in the vending machine for that ticket drawer, the vending machine knows the parameter for the lottery ticket pack that was previously loaded and can update them as necessary. If the parameters for a lottery ticket pack in a ticket drawer are not already present in the vending machine for that ticket drawer, then the vending machine can load those parameters to be in association with that ticket drawer. If different from lottery ticket game previously loaded in that ticket drawer, the vending machine can use the new parameters for that lottery ticket game to replace the parameters for the old replaced lottery tickets in that ticket drawer.

Responsive to the controller determining that the lottery ticket pack was not previously loaded, the controller determines the new game parameters for association with that ticket drawer, as indicated by block 546. These parameters can include, for example, the price point of each lottery ticket, physical ticket length, lottery game name, and/or lottery game ID.

In various embodiments, the vending machine 100 can optionally include various lottery ticket management modes for loaded lottery ticket packs, as indicated by block 548. In various embodiments, these lottery ticket management modes can include, for example, a ticket-by-ticket (“TBT”) activation mode (where the ticket pack is activated but each lottery ticket is not activated until that lottery ticket is purchased), or a pack activation mode (where each lottery ticket in a loaded lottery ticket pack is activated prior to purchase).

Responsive to the controller determining that the lottery ticket group was previously loaded or after getting the new game parameters if the lottery ticket group not previously loaded, the controller loads the game identification information, as indicated by block 550. In various example embodiments, the game identification information includes the purchase price of each lottery ticket in the lottery ticket pack, the overall physical length of a lottery ticket in the lottery ticket pack, and the number of retries (if needed). It should be appreciated that the game ID can be read from the barcode on back of the first lottery ticket. The first few digits in the barcode are expected to be the game ID.

As mentioned above, in various embodiments, the vending machine 100 assume that if lottery ticket packs are taped together, they are for the same lottery game. In various embodiments, the vending machine can ask the operator to confirm that lottery ticket packs taped together are for the same lottery game. In various embodiments, the vending machine can ask the operator to input via the management user interface, the respective lottery games for the lottery ticket packs taped together.

In various embodiments, the quantity of retries are the quantity of lottery ticket activation requests after a first request is denied or no request is received from a central lottery system.

After the controller loads the game identification information for the lottery ticket group in the ticket drawer, the controller causes the management user interface to display an indication that the lottery ticket group was loaded in this ticket drawer, as indicated by block 552.

The controller determines whether there are additional ticket drawers to autoload, as indicated by bock 554.

Responsive to the controller determining that there are no additional ticket drawers to autoload, the loading process is complete, as indicated by block 556.

Responsive to the controller determining that there are one or more additional ticket drawers to autoload, the autoload process for the respective next ticket drawer is performed, and the process for the next ticket drawer includes the steps described above as indicated by blocks 522 through 554.

It should be appreciated that if a new lottery game is autoloaded, once the parameters for that new lottery game have been stored and the door is closed, the vending machine can enable the operator to modify the planogram of the ticket purchase interface to rearrange the layout of the available lottery tickets such as but not limited to: a purchase price ascending layout, a purchase price descending, or an operated selected custom layout.

FIG. 11 illustrates one example instant ticket purchasing and dispensing method 600 in accordance with one embodiment of the present disclosure.

The vending machine 100 is configured to enable a purchaser to add credits to the vending machine 100, as indicated by block 602. In various embodiments, the purchaser can insert money or present a credit card, a debit card, or ticket voucher to add credits to the vending machine 100.

The controller causes the display device of the vending machine 100 to display the purchaser lottery ticket selection user interface, which enables the purchaser to select one or more lottery tickets for purchase with the credits deposited on the vending machine by the purchaser, as indicated by block 604.

The vending machine 100 is configured to enable the purchaser to select each of one or more lottery tickets for purchase, as indicated by block 606. While the purchaser can select more than one lottery ticket, the method described below is primarily described for one example lottery ticket selected by the purchaser for simplicity and brevity. It should be appreciated that the method can be repeated for each lottery ticket selected by the purchaser. In various embodiments, the vending machine 100 enables the purchase to select one or more lottery tickets and place those selected lottery ticket in a shopping cart, and then enables the player to pay for all of the lottery tickets in the shopping cart via cash or suitable credit or debit card.

The controller determines the ticket drawer in which the selected lottery ticket is located and the column of the vending machine 100 in which that ticket drawer is located. The controller communicates with the burster controller of the burster associated with that column to cause that burster to move into alignment with the determined ticket drawer, as indicated by block 608. If more than one lottery ticket is selected, and the controller determines that the such selected lottery tickets are in different ticket drawers, the controller determines the ticket drawer in which the first of the selected locket tickets is located and the column in which that ticket drawer is located and first performs the process for that ticket drawer, and then subsequently performs the process for the respective ticket drawer for each next selected lottery ticket.

The burster controller causes the burster to move into alignment with the determined ticket drawer in which the purchaser selected lottery ticket is located and causes the burster to pull the leading lottery ticket in the lottery ticket group of the determined ticket drawer from the determined ticket drawer and into the burster, as indicated by block 610. In this example, the ticket engagers of the burster grip and then move the leading lottery ticket of the lottery ticket group into the burster.

The method described below is primarily for example situations in which a selected lottery ticket is located in only one ticket drawer of the vending machine. In alternative embodiments, a selected lottery ticket can be located in more than one ticket drawer of the vending machine, such as a first drawer and a second drawer, and portions of the method 600 may repeat such that the burster controller causes the burster to move to the second drawer if the selected lottery ticket is not successfully obtained from the selected first ticket drawer.

The ticket sensor of the burster reads the ticket barcode of the leading lottery ticket of the lottery ticket group in the ticket drawer that is pulled into the ticket burster from the ticket drawer, as indicated by block 612. The ticket sensor sends the barcode image data to the controller of the vending machine 100.

The controller determines whether the ticket sensor successfully read data associated with the lottery ticket game expected to correspond with the purchaser-selected lottery ticket, as indicated by block 614. This data is obtained during the ticket loading process described above.

The portion of the method 600 following a determination of “no” is referred to herein as the “unsuccessful read” portion.

The portion of the method 600 following a determination of “yes” is referred to herein as the “successful read” portion.

Responsive to the controller determining that the ticket sensor did not successfully read data associated with the expected lottery game, the “unsuccessful read” portion of method 600 begins.

The controller determines whether the ticket sensor read data associated with a different lottery game, as indicated by block 616.

The portion of the method 600 following a determination of “no” is referred to herein as the “unknown game” portion.

The portion of the method 600 following a determination of “yes” is referred to herein as the “different game” portion.

As indicated above, the data related to the previously loaded game is stored in memory of the controller of the vending machine 100 and is associated with a particular ticket drawer during the loading process. If the burster reads a barcode that is different from that which was previously loaded, in various embodiments, the controller will “unload/replace” the previous lottery game for that ticket drawer and “load” or assign the new lottery game to that ticket drawer and retrieve the appropriate data to subsequently display on purchaser lottery ticket selection user interface for that new determined lottery game.

### Unknown Game Portion of Method

Responsive to the controller determining that the ticket sensor did not read data associated with a different lottery game, the “unknown game” portion of method 600 begins. In this situation, the vending machine 100 is unable to identity the lottery game associated with the leading lottery ticket of the lottery ticket group in the ticket drawer. The controller communicates with the burster controller to cause the burster to return the leading lottery ticket of the lottery ticket group to the determined ticket drawer, as indicated by block 618. In this example, the ticket engagers of the burster move the leading lottery ticket back into the determined ticket drawer and release the leading lottery ticket. Thus, the barcode of the leading lottery ticket is always read, and if the barcode is invalid, an error message is sent and/or displayed, and then the vending machine 100 can take a suitable action based on the new lottery ticket data determined for that ticket drawer.

In various embodiments, since the ticket drawer does not appear to have the correct lottery ticket, the controller disables that ticket drawer, as indicated by block 620. In certain embodiments, the controller can change the status indication of the lottery ticket inventory of the determined ticket drawer to indicate that the ticket drawer is disabled. The indicator can indicate to an operator to replace the lottery ticket group in that ticket drawer such that, during a subsequent loading process, an operator can remove the lottery ticket group associated with the unknown lottery game and load lottery tickets into that ticket drawer that are associated with a lottery game that the vending machine 100 can identity.

In such situations, the controller also causes the display device of the vending machine 100 to remove the selected lottery ticket from the purchaser lottery ticket selection user interface such that the selected lottery ticket is no longer displayed as available to purchase, as indicated by block 622.

In such situations, the controller causes the display device of the vending machine 100 to display a notification to the purchaser that the selected lottery ticket cannot be purchased, as indicated by block 624. In various embodiments, the controller causes the display device to display an option to select a different lottery ticket or to receive a refund of the credits used to purchase the selected lottery ticket.

The “unknown game” portion of method 600 ends at this point, but the method 600 continues to the next block.

The vending machine is configured to enable the purchaser to make a second lottery ticket selection, as indicated by block 626.

Responsive to the purchaser making a second lottery ticket selection, the vending machine repeats a portion of the method 600, starting with the controller determining the ticket drawer in which the second lottery ticket selected is located and the column in which that ticket drawer is located. The controller communicates with the burster controller associated with that ticket drawer to cause that burster to move into alignment with that determined ticket drawer in that ticket column, as indicated by block 608. In such situations, the respective appropriate steps of the method 600 are repeated.

### Different Game Portion of Method

Returning to block 616, responsive to the controller determining that the ticket sensor did read data associated with a different lottery game, the “different game” portion of method 600 begins. In this situation, the vending machine 100 is able to identity the lottery game associated with the leading lottery ticket of the lottery ticket group pulled from the ticket drawer, but the lottery game is different from the lottery game associated with the purchaser-selected lottery ticket. The controller communicates with the burster controller to cause the burster to return the leading lottery ticket of the lottery ticket group to the determined ticket drawer, as indicated by block 628. In this example, the ticket engagers of the burster move the leading lottery ticket back into the determined ticket drawer and release that leading lottery ticket.

The controller causes the display device of the vending machine 100 to notify the purchaser that the selected lottery ticket associated with the selected lottery ticket game is unavailable in the vending machine 100, as indicated by block 630. As discussed above, in alternative embodiments in which a selected lottery ticket may be located in a first drawer and also in a second drawer, respective appropriate portions of the method 600 can repeat with respect to that second drawer to try to provide the purchaser that selected lottery ticket. For example, the burster controller can cause the burster to move to the second drawer and read the leading lottery ticket of the lottery ticket group in that second drawer prior to displaying the notification to the purchaser that the selected lottery ticket is unavailable for purchase.

The controller loads the different new lottery game associated with the leading lottery ticket of the lottery ticket group, as indicated by block 632.

The controller loads the game parameters associated with the game, as indicated by block 634. The game parameters can include, for example, various instant ticket management modes, as indicated by block 636. In this example, these ticket management modes can include one of the modes discussed above. The parameters can include, for example, lottery game name, lottery game ID, lottery game price point, and lottery ticket length.

The controller loads the game identification data, as indicated by block 638. In this example, the game identification data includes the price of a lottery ticket in the lottery ticket pack in the ticket drawer, the overall physical length of a lottery ticket in the lottery ticket pack, and the number of retries if needed.

The pack information is configured such that the vending machine 100 associates the leading lottery ticket of the lottery ticket group of that determined ticket drawer with the different lottery game, as indicated by block 640. A lottery ticket associated with the different lottery ticket game will be available for purchaser selection during the next lottery ticket selection. In certain embodiments, the controller causes the display device of the vending machine 100 to add the lottery ticket to the purchaser lottery ticket selection user interface such that the lottery ticket is displayed as available to purchase.

The “unknown game” and/or “different game” portions of method 600 end at this point, but after the pack information is configured, a portion of the method 600 repeats, starting with vending machine being configured to enable the purchaser to make another lottery ticket selection, as indicated by block 626.

### Successful Read Portion of Method

Returning to block 614, responsive to the controller determining that the ticket sensor successfully read data associated with the expected lottery game, the “successful read” portion of method 600 begins.

The controller sends a request to the server to host the lottery game, as indicated by block 642. The server approves the request and sends data such as the instant lottery ticket management mode corresponding to the lottery game.

The controller determines whether the lottery ticket has been activated, as indicated by block 644. The determination of whether the lottery ticket has been activated can be based on the employed respective lottery ticket management mode, as indicated by block 646.

It should be appreciated that if a lottery ticket is not activated, that lottery ticket has no value. When the barcode of that lottery ticket is scanned during the purchase process, the vending machine 100 will send an activation request to the central lottery system. If the request is successful, the lottery ticket is considered activated with a value, meaning that any winning prizes claimed for that lottery ticket are valid and can be redeemed.

Responsive to the controller determining that the lottery ticket has not been activated, a portion of the method repeats, starting with the burster controller causing the burster to return the first lottery ticket to the ticket drawer, as indicated by block 618. The lottery ticket can only be activated if purchased, or in the case of a mode with pack activation when they are loaded. It should be appreciated that in certain embodiments, a lottery ticket not being activated indicates that the lottery ticket game associated with the selected lottery ticket is no longer available.

Responsive to the controller determining that the lottery ticket has been activated, a portion of the method referred to herein as the “following ticket” portion begins. This portion enables the vending machine 100 to obtain additional data about the lottery ticket group in the respective ticket drawer, and if necessary, preemptively load an additional lottery ticket game during the method of dispensing the leading lottery ticket in the lottery ticket group in that ticket drawer. During this portion, the leading lottery ticket of the lottery ticket group from the ticket drawer remains in the burster and the burster controller causes the burster to move the second lottery ticket of the lottery ticket group in that ticket drawer, (which can be referred to alternatively as the following lottery ticket) into the burster.

The ticket sensor of the burster reads the ticket barcode of the second lottery ticket of the lottery ticket group from the ticket drawer, as indicated by block 650. The ticket sensor sends the barcode image data to the controller.

The controller determines whether the ticket sensor read data associated with a new lottery ticket game, as indicated by block 652. In this example, the controller makes this determination in part by comparing the game data associated with the second lottery ticket of the lottery ticket group from the ticket drawer to game data already loaded into the vending machine.

Responsive to the controller determining that the ticket sensor read data associated with a new lottery ticket game, a portion of the method 600 repeats, starting with the controller loading the new lottery ticket game associated with the second lottery ticket of the lottery ticket group from the ticket drawer, as indicated by block 632, and ending with the pack information being configured such that a lottery ticket associated with the new lottery ticket game will be available for purchaser selection during the next lottery ticket selection, as indicated by block 640.

The controller then communicates with the burster controller to cause the burster to return the second lottery ticket of the lottery ticket group back to the ticket drawer while keeping the leading lottery ticket of the lottery ticket group from the ticket drawer in the burster. In this example, the ticket engagers of the burster move the second lottery ticket of the lottery ticket group back into the ticket drawer and release that second lottery ticket.

The method 600 then continues to block 654.

Responsive to the controller determining that the ticket sensor did not read data associated with a new lottery ticket game, the controller communicates with the burster controller to cause the burster to return the second lottery ticket of the lottery ticket group to the ticket drawer while keeping the leading lottery ticket of the lottery ticket group in the burster. In this example, the ticket engagers of the burster move the second lottery ticket of the lottery ticket group back into the ticket drawer for release of that second lottery ticket.

The controller communicates with the burster controller to cause the burster to separate the leading lottery ticket of the lottery ticket group from the second lottery ticket, as indicated by block 654. In this example, burster controller causes the ticket cutter of the burster to rotate to cut the perforations attaching the leading lottery ticket of the lottery ticket group to the second lottery ticket of the lottery ticket group. In various embodiments, if it is determined that the second lottery ticket in the group is different and the player wished to purchase multiples of the originally loaded lottery ticket, the vending machine 100 can display an error message indicating that the lottery ticket is not available and to make another selection. In the case of the shopping cart embodiment, the message can appear saying that the desired quantity is not available. The vending machine 100 enables the player to either choose a lesser quantity of the desired lottery ticket or choose a different lottery ticket.

It should be appreciated that alternatively the cutter of the burster can separate the leading lottery ticket from the second ticket earlier in the process such that while the second lottery ticket is scanned and otherwise being processed as described above, the leading lottery ticket has already been separated from the second lottery ticket.

After the leading lottery ticket is cut and thus separated from the second lottery ticket, the burster controller causes the burster, with the cut leading lottery ticket inside the burster, to travel to the ticket collection receptacle 250 of the front door 200, as indicated by block 656.

The burster controller causes the burster to dispense the cut leading lottery ticket into the ticket collection receptacle 250, as indicated by block 658. In certain embodiments, the ticket engagers of the burster grip and then move the separated leading lottery ticket out of the burster such that the cut leading lottery ticket moves into the ticket collection receptacle 250.

The controller determines if the purchaser selected one or more additional lottery tickets to dispense, as indicated by block 660.

Responsive to the controller determining that the purchaser selected an additional lottery ticket to dispense, one or more of the above described portions of the method 600 repeats, starting with the controller determining the ticket drawer in which the next purchaser selected lottery tickets is located and the column in which that ticket drawer is located. The controller communicates with the burster controller of the burster associated with that column to cause that burster to move into alignment with the determined ticket drawer, as indicated by block 608, and then starts the appropriate respective portions of the above described method.

Responsive to the controller determining that the purchaser did not select one or more additional lottery tickets to dispense, the vending machine 100 is configured to enable the purchaser to take the dispensed purchaser-selected lottery ticket from ticket collection receptacle 250, as indicated by block 662.

It should be appreciated from the above that various embodiments of the present disclosure provide a lottery ticket vending machine comprising: a housing; a display device supported by the housing; a ticket drawer in the housing the ticket drawer configured to hold a group of lottery tickets; a ticket burster in the housing, the ticket burster defining a ticket inlet and a ticket outlet, the ticket burster movable into alignment with the ticket drawer, the ticket burster comprising a sensor; and a controller. The controller is configured to: (1) cause a display by the display device of a purchaser lottery ticket selection user interface that indicates a plurality of different selectable lottery games; (2) based on a purchaser selected lottery game from the plurality of different selectable lottery games, cause the burster to be in alignment with the ticket drawer; (3) cause the burster to obtain a leading lottery ticket from the group of lottery tickets in the ticket drawer; (4) based on determined barcode image data for the leading lottery ticket, determine whether the leading lottery ticket is for the purchaser selected lottery game; (5) responsive to determining that the leading lottery ticket is for the purchaser selected lottery game, cause the burster to separate the leading lottery ticket from a second lottery ticket of the group of lottery tickets in the ticket drawer and to dispense that leading lottery ticket; and (6) responsive to determining that the leading lottery ticket is not for the purchaser selected lottery game: (a) cause the burster to return the leading lottery ticket to the ticket drawer, (b) cause the display by the display device of an indication that that the purchaser selected lottery game is not available, and (c) cause the purchaser lottery ticket selection user interface to remove the indication that the purchaser selected lottery game is available for purchase. In various such embodiments, the controller is further configured to, based on determined barcode image data for the leading lottery ticket, determine whether the group of lottery tickets comprises a partial lottery ticket pack. In various such embodiments, the controller is further configured to, based on a user input determine, whether the group of lottery tickets comprises a partial lottery ticket pack. In various such embodiments, the controller is further configured to cause the display device to display a management screen user interface that enables operator input of partial pack data for the group of lottery tickets. In various such embodiments, the controller is further configured to, responsive to a determination that the group of lottery tickets includes a partial pack, determine start and end of pack information for that partial pack. In various such embodiments, the controller is further configured to, responsive to determining that game parameter data for the group of lottery tickets was not previously loaded, obtain game identification information for the group of lottery tickets. In various such embodiments, the controller is further configured to, after determining that the leading lottery ticket is for the purchaser selected lottery game, cause a determination of whether the second lottery ticket of the group of lottery tickets that is attached to the leading lottery ticket is also for the purchaser selected lottery game. In various such embodiments, the controller is further configured to, after determining that the lottery game for the second lottery ticket is for the purchaser selected lottery game, return the second lottery ticket to the ticket drawer. In various such embodiments, the controller is further configured to, after determining that the lottery game for the second lottery ticket is not for the purchaser selected lottery game, return the second lottery ticket to the ticket drawer, cause the display by the display device of an indication that that the purchaser selected lottery game is not available, and cause the purchaser lottery ticket selection user interface to remove the indication that the purchaser selected lottery game is available for purchase.

It should further be appreciated from the above that various embodiments of the present disclosure provide a lottery ticket vending machine comprising: a housing; a display device supported by the housing; a ticket drawer in the housing the ticket drawer configured to hold a group of lottery tickets; a ticket burster in the housing, the ticket burster defining a ticket inlet and a ticket outlet, the ticket burster movable into alignment with the ticket drawer, the ticket burster comprising a sensor; and a controller. The controller is configured to: (1) cause a display by the display device of a purchaser lottery ticket selection user interface that indicates a plurality of different selectable lottery games; (2) based on a purchaser selected lottery game from the plurality of different selectable lottery games, cause the burster to be in alignment with the ticket drawer; (3) cause the burster to obtain a leading lottery ticket from the group of lottery tickets in the ticket drawer; (4) based on first determined barcode image data for the leading lottery ticket, cause the burster to separate the leading lottery ticket from a second lottery ticket of the group of lottery tickets in the ticket drawer and to dispense that leading lottery ticket; and (5) based on second determined barcode image data for the second lottery ticket of the group of lottery tickets in the ticket drawer, responsive to determining that the second lottery ticket is for a different lottery game: (a) cause the burster to return the second lottery ticket to the ticket drawer, and (b) cause the purchaser lottery ticket selection user interface to subsequently add an indication that the different lottery game is available for purchase. In various such embodiments, the controller is further configured to, based on a user input determine, whether the group of lottery tickets comprises a partial lottery ticket pack. In various such embodiments, the controller is further configured to, based on a user input determine, whether the group of lottery tickets comprises multiple lottery ticket packs. In various such embodiments, the controller is further configured to cause the display device to display a management screen user interface that enables operator input of partial pack data for the group of lottery tickets. In various such embodiments, the controller is further configured to cause the display device to display a management screen user interface that enables operator input of multiple pack data for the group of lottery tickets.

It should be appreciated from the above that various embodiments of the present disclosure provide a lottery ticket vending machine comprising: a housing; a display device supported by the housing; a ticket drawer in the housing the ticket drawer configured to hold a group of lottery tickets; a ticket burster in the housing, the ticket burster defining a ticket inlet and a ticket outlet, the ticket burster movable into alignment with the ticket drawer, the ticket burster comprising a sensor; and a controller. The controller is configured to: (1) cause a display by the display device of a purchaser lottery ticket selection user interface that indicates a plurality of different selectable lottery games; (2) based on a purchaser selected lottery game from the plurality of different selectable lottery games, cause the burster to be in alignment with the ticket drawer; (3) cause the burster to obtain a leading lottery ticket from the group of lottery tickets in the ticket drawer; (4) based on first determined barcode image data for the leading lottery ticket, cause the burster to separate the leading lottery ticket from a second lottery ticket of the group of lottery tickets in the ticket drawer and to dispense that leading lottery ticket; and (5) based on second determined barcode image data for the second lottery ticket of the group of lottery tickets in the ticket drawer, responsive to determining that the second lottery ticket is not for the purchaser selected lottery game: (a) cause the burster to return the second lottery ticket to the ticket drawer, (b) cause the purchaser lottery ticket selection user interface to remove the indication that the purchaser selected lottery game is available for purchase, and (c) cause the purchaser lottery ticket selection user interface to add an indication that a different lottery game associated with the second lottery ticket is available for purchase. In various such embodiments, the controller is further configured to, based on a user input determine, whether the group of lottery tickets comprises multiple lottery ticket packs. In various such embodiments, the controller is further configured to cause the display device to display a management screen user interface that enables operator input of multiple pack data for the group of lottery tickets. In various such embodiments, the controller is further configured to determine game parameters for the second lottery ticket. In various such embodiments, the controller is further configured to cause the display device to display one an indication of one of the determined game parameters for the second lottery ticket. In various such embodiments, the controller is further configured to associate the game parameters for the second lottery ticket with the ticket drawer.

It should also be appreciated from the above that various embodiments of the present disclosure provide a lottery ticket vending machine comprising: a housing; a plurality of ticket drawers in the housing, each of the plurality of ticket drawers configured to hold a group of lottery tickets; a ticket burster in the housing, the ticket burster defining a ticket inlet and a ticket outlet, the ticket burster movable to a plurality of different ticket receipt positions each respectively associated with and in alignment with a different one of the plurality of ticket drawers, the ticket burster comprising a sensor; a processor in the housing; and a memory device in the housing and that stores a plurality of instructions. When executed by the processor, the plurality of instructions cause the processor to: (1) based on determined barcode image data for a leading lottery ticket in the group of lottery tickets in the plurality of ticket drawers, determine whether the group of lottery tickets comprises a partial lottery ticket pack, and (2) responsive to determining that game parameter data for the group of lottery tickets was not previously loaded, obtain game identification information for the group of lottery tickets. In various such embodiments, when executed by the processor, the plurality of instructions cause the processor to, responsive to a determination that the group of lottery tickets includes a partial pack, determine start and end of pack information for that partial pack. In various such embodiments, when executed by the processor, the plurality of instructions cause the processor to, responsive to a determination that game parameter data for the group of lottery tickets was not previously loaded, obtain the game parameter data for the group of lottery tickets.

It should also be appreciated from the above that various embodiments of the present disclosure provide a lottery ticket vending machine comprising: a housing; a plurality of ticket drawers in the housing, each of the plurality of ticket drawers configured to hold a group of lottery tickets; a ticket burster in the housing, the ticket burster defining a ticket inlet and a ticket outlet, the ticket burster movable to a plurality of different ticket receipt positions each respectively associated with and in alignment with a different one of the plurality of ticket drawers, the ticket burster comprising a sensor; a processor in the housing; and a memory device in the housing and storing a plurality of instructions. When executed by the processor, the instructions cause the processor to: (1) based on determined first barcode image data for a leading lottery ticket in a group of lottery tickets in one of the plurality of ticket drawers, determine whether the first barcode image data is associated with a first lottery game, send a request to host the first lottery game; (2) based on determined second barcode image data for a second lottery ticket in the group of lottery tickets in the one of the plurality of ticket drawers, determine whether the second barcode image data is associated with a second lottery game, and (3) cause the burster to cut and dispense the first lottery ticket from the second lottery ticket. In various such embodiments, when executed by the processor, the plurality of instructions cause the processor to, responsive to a determination that the first barcode image data is not associated with the first lottery game, determine whether the first barcode image data is associated with a third lottery game. In various such embodiments, when executed by the processor, the plurality of instructions cause the processor to, responsive to a determination that the first barcode image data is associated with the third lottery game, cause the burster to return the first lottery ticket to the one of the plurality of ticket drawers. In various such embodiments, when executed by the processor, the plurality of instructions cause the processor to, responsive to a determination that the first barcode image data is associated with the third lottery game, retrieve first game parameters associated with the third lottery game and game identification information associated with the third lottery game. In various such embodiments, when executed by the processor, the plurality of instructions cause the processor to, responsive to a determination that the second barcode image data is associated with the second lottery game, retrieve second game parameters associated with the second lottery game and second game identification information associated with the second lottery game.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The claims are as follows:

1. A lottery ticket vending machine comprising:
a housing;
a display device supported by the housing;
a ticket drawer in the housing the ticket drawer configured to hold a group of lottery tickets;
a ticket burster in the housing, the ticket burster defining a ticket inlet and a ticket outlet, the ticket burster movable into alignment with the ticket drawer, the ticket burster comprising a sensor;
a processor in the housing; and
a memory device in the housing and that stores a plurality of instructions, which when executed by the processor, cause the processor to:
cause a display by the display device of a purchaser lottery ticket selection user interface that indicates a plurality of different selectable lottery games;
based on a purchaser selected lottery game from the plurality of different selectable lottery games, cause the burster to be in alignment with the ticket drawer;
cause the burster to obtain a leading lottery ticket from the group of lottery tickets in the ticket drawer;
based on determined barcode image data for the leading lottery ticket, determine whether the leading lottery ticket is for the purchaser selected lottery game;
responsive to determining that the leading lottery ticket is for the purchaser selected lottery game, cause the burster to separate the leading lottery ticket from a second lottery ticket of the group of lottery tickets in the ticket drawer and to dispense that leading lottery ticket; and
responsive to determining that the leading lottery ticket is not for the purchaser selected lottery game:
cause the burster to return the leading lottery ticket to the ticket drawer,
cause the display by the display device of an indication that that the purchaser selected lottery game is not available, and
cause the purchaser lottery ticket selection user interface to remove the indication that the purchaser selected lottery game is available for purchase.

2. The lottery ticket vending machine of claim 1, wherein when executed by the processor, the plurality of instructions cause the processor to: based on determined barcode image data for the leading lottery ticket, determine whether the group of lottery tickets comprises a partial lottery ticket pack.

3. The lottery ticket vending machine of claim 1, wherein when executed by the processor, the plurality of instructions cause the processor to: based on a user input determine whether the group of lottery tickets comprises a partial lottery ticket pack.

4. The lottery ticket vending machine of claim 1, wherein when executed by the processor, the plurality of instructions cause the processor to cause the display device to display a management screen user interface that enables operator input of partial pack data for the group of lottery tickets.

5. The lottery ticket vending machine of claim 1, wherein when executed by the processor, the plurality of instructions cause the processor to, responsive to a determination that the group of lottery tickets includes a partial pack, determine start and end of pack information for that partial pack.

6. The lottery ticket vending machine of claim 1, wherein when executed by the processor, the plurality of instructions cause the processor to: responsive to determining that game parameter data for the group of lottery tickets was not previously loaded, obtain game identification information for the group of lottery tickets.

7. The lottery ticket vending machine of claim 1, wherein when executed by the processor, the plurality of instructions cause the processor to: after determining that the leading lottery ticket is for the purchaser selected lottery game, cause a determination of whether the second lottery ticket of the group of lottery tickets that is attached to the leading lottery ticket is also for the purchaser selected lottery game.

8. The lottery ticket vending machine of claim 7, wherein when executed by the processor, the plurality of instructions cause the processor to: after determining that the lottery game for the second lottery ticket is for the purchaser selected lottery game, return the second lottery ticket to the ticket drawer.

9. The lottery ticket vending machine of claim 7, wherein when executed by the processor, the plurality of instructions cause the processor to: after determining that the lottery game for the second lottery ticket is not for the purchaser selected lottery game, return the second lottery ticket to the ticket drawer, cause the display by the display device of an indication that that the purchaser selected lottery game is not available, and cause the purchaser lottery ticket selection user interface to remove the indication that the purchaser selected lottery game is available for purchase.

10. A lottery ticket vending machine comprising:
a housing;
a display device supported by the housing;
a ticket drawer in the housing the ticket drawer configured to hold a group of lottery tickets;
a ticket burster in the housing, the ticket burster defining a ticket inlet and a ticket outlet, the ticket burster movable into alignment with the ticket drawer, the ticket burster comprising a sensor;
a processor in the housing; and
a memory device in the housing and that stores a plurality of instructions, which when executed by the processor, cause the processor to:
cause a display by the display device of a purchaser lottery ticket selection user interface that indicates a plurality of different selectable lottery games;
based on a purchaser selected lottery game from the plurality of different selectable lottery games, cause the burster to be in alignment with the ticket drawer;
cause the burster to obtain a leading lottery ticket from the group of lottery tickets in the ticket drawer;
based on first determined barcode image data for the leading lottery ticket, cause the burster to separate the leading lottery ticket from a second lottery ticket of the group of lottery tickets in the ticket drawer and to dispense that leading lottery ticket; and
based on second determined barcode image data for the second lottery ticket of the group of lottery tickets in the ticket drawer, responsive to determining that the second lottery ticket is for a different lottery game:
cause the burster to return the second lottery ticket to the ticket drawer, and
cause the purchaser lottery ticket selection user interface to subsequently add an indication that the different lottery game is available for purchase.

11. The lottery ticket vending machine of claim 10, wherein when executed by the processor, the plurality of instructions cause the processor to: based on a user input determine whether the group of lottery tickets comprises a partial lottery ticket pack.

12. The lottery ticket vending machine of claim 10, wherein when executed by the processor, the plurality of instructions cause the processor to: based on a user input determine whether the group of lottery tickets comprises multiple lottery ticket packs.

13. The lottery ticket vending machine of claim 10, wherein when executed by the processor, the plurality of instructions cause the processor to cause the display device to display a management screen user interface that enables operator input of partial pack data for the group of lottery tickets.

14. The lottery ticket vending machine of claim 10, wherein when executed by the processor, the plurality of instructions cause the processor to cause the display device to display a management screen user interface that enables operator input of multiple pack data for the group of lottery tickets.

15. A lottery ticket vending machine comprising:
a housing;
a display device supported by the housing;
a ticket drawer in the housing the ticket drawer configured to hold a group of lottery tickets;
a ticket burster in the housing, the ticket burster defining a ticket inlet and a ticket outlet, the ticket burster movable into alignment with the ticket drawer, the ticket burster comprising a sensor;
a processor in the housing; and
a memory device in the housing and that stores a plurality of instructions, which when executed by the processor, cause the processor to:
cause a display by the display device of a purchaser lottery ticket selection user interface that indicates a plurality of different selectable lottery games;
based on a purchaser selected lottery game from the plurality of different selectable lottery games, cause the burster to be in alignment with the ticket drawer;
cause the burster to obtain a leading lottery ticket from the group of lottery tickets in the ticket drawer;
based on first determined barcode image data for the leading lottery ticket, cause the burster to separate the leading lottery ticket from a second lottery ticket of the group of lottery tickets in the ticket drawer and to dispense that leading lottery ticket; and
based on second determined barcode image data for the second lottery ticket of the group of lottery tickets in the ticket drawer, responsive to determining that the second lottery ticket is not for the purchaser selected lottery game:
cause the burster to return the second lottery ticket to the ticket drawer,
cause the purchaser lottery ticket selection user interface to remove the indication that the purchaser selected lottery game is available for purchase, and
cause the purchaser lottery ticket selection user interface to add an indication that a different lottery game associated with the second lottery ticket is available for purchase.

16. The lottery ticket vending machine of claim 15, wherein when executed by the processor, the plurality of instructions cause the processor to: based on a user input determine, whether the group of lottery tickets comprises multiple lottery ticket packs.

17. The lottery ticket vending machine of claim 15, wherein when executed by the processor, the plurality of instructions cause the processor to cause the display device to display a management screen user interface that enables operator input of multiple pack data for the group of lottery tickets.

18. The lottery ticket vending machine of claim 15, wherein when executed by the processor, the plurality of instructions cause the processor to determine game parameters for the second lottery ticket.

19. The lottery ticket vending machine of claim 15, wherein when executed by the processor, the plurality of instructions cause the processor to cause the display device to display one an indication of one of the determined game parameters for the second lottery ticket.

20. The lottery ticket vending machine of claim 15, wherein when executed by the processor, the plurality of instructions cause the processor to associate the game parameters for the second lottery ticket with the ticket drawer.
